(19) United States
(12) Patent Application Publication
(10) Pub. No.: US 2012/0144399 A1
(43) Pub. Date: Jun. 7, 2012

(54) APPARATUS AND METHOD FOR SYNCHRONIZATION OF THREADS

(76) Inventors: Won Sub KIM, Anyang-si (KR); Bernhard EGGER, Seoul (KR); Dong-Hoon YOO, Seoul (KR); Jin-Seok LEE, Seoul (KR); Taisong JIN, Seoul (KR)

(21) Appl. No.: 13/217,498

(22) Filed: Aug. 25, 2011

(30) Foreign Application Priority Data
Dec. 3, 2010 (KR) 10-2010-0122946

(51) Int. Cl. G06F 9/46

(52) U.S. Cl. 718/106

(57) ABSTRACT

A method and apparatus for thread synchronization is provided. The apparatus for thread synchronization includes a reader configured to generate a data read request, a writer configured to generate a data write request, a register file configured to have a full status indicating that the register file stores data and an empty status indicating that the register file stores no data, and a controller configured to receive the data read request from the reader or the data write request from the writer, and to process the received data read request or the received data write request while stalling or releasing the reader or the writer according to whether the register file is in the full status or in the empty status and according to an operating status of the reader or the writer.

### CROSS-REFERENCE TO RELATED APPLICATION

This application claims the benefit under 35 U.S.C. §119(a) of Korean Patent Application No. 10-2010-0122946, filed on Dec. 3, 2010, the entire disclosure of which is incorporated herein by reference for all purposes.

### BACKGROUND

1. Field

The following description relates to thread synchronization.

2. Description of the Related Art

In data processing, a thread of execution, or simply a thread, is generally the smallest unit of processing that is scheduled by a processor. A plurality of threads may exist in a process, and these threads may also share memory resources. Problems may occur in a case in which two or more threads access the same method to exchange data. For example, if one thread B changes a data value in a method while another thread A is being executed, unexpected results may appear. Thread synchronization is a technique for preventing two or more threads from simultaneously referring to shared data.

One conventional thread synchronization technique is the use of a semaphore. The semaphore method is a mutual exclusion method that is applied in a case in which n processes (or n threads) share m resources. Thread synchronization through the use of the semaphore involves defining a certain shared variable s and deciding an operation of each thread according to the s value while increasing or decreasing the s value.

However, thread synchronization techniques such as the use of the semaphore require a programmer's direct programming to define a shared variable to prevent two or more threads from simultaneously referring to shared data.

In particular, recently, with the appearance and development of various multi-threading environments, the implementation of thread synchronization through a programmer's programming is very inefficient in many cases.

### SUMMARY

In one general aspect, there is provided a thread synchronization apparatus including a reader configured to generate a data read request, a writer configured to generate a data write request, a register file configured to have a full status indicating that the register file stores data and an empty status indicating that the register file stores no data, and a controller configured to receive the data read request from the reader or the data write request from the writer, and to process the received data read request or the received data write request while stalling or releasing the reader or the writer according to whether the register file is in the full status or in the empty status and according to an operating status of the reader or the writer.

The controller may stall the reader in response to the register file being in the empty status and the data read request being received from the reader.

The controller may stall the reader until the register file enters the full status due to the data write request from the writer being processed.

The controller may change the register file to the full status in response to processing the data write request from the writer.

If the register file is in the full status and the data read request is received from the reader, the controller may process the received data read request, determine whether the writer is in a stalled status, and release, in response to the writer being in the stalled status, the stalled status of the writer.

If the register file is in the full status and the data write request is received from the writer, the controller may stall the writer.

The controller may stall the writer until the register file enters the empty status due to the data read request from the reader being processed.

The controller may change the register file to the empty status in response to processing the data read request from the reader.

If the register file is in the empty status and the data write request is received from the writer, the controller may process the received data write request, determine whether the reader is in a stalled status, and release, in response to the reader being in the stalled status, the stalled status of the reader.

The register file may include a first area for storing data indicating the full status or the empty status, and a second area for storing data corresponding to the data read request or the data write request.

In another general aspect, there is provided a thread synchronization apparatus configured to stall a first thread until a register file is filled with data by a second thread, in response to the register file being empty and the first thread generating a data read request for reading data stored in the register file, and to stall a third thread until the register file is empty due to processing a fourth thread, in response to the register file being filled with data and the third thread generating a data write request for writing data to the register file.

In another general aspect, there is provided a thread synchronization method including receiving a data read request from a reader or a data write request from a writer, determining whether a register file is in a full status or empty status, wherein the full status indicates that the register file stores data and the empty status indicates that the register file stores no data, determining whether the reader or the writer is in a stalled status or in a released status, and processing the received data read request or the received data write request while stalling or releasing the reader or the writer according to whether the register file is in the full status or in the empty status and according to an operating status of the reader or the writer.

The reader may be stalled in response to the register file being in the empty status.

The reader may be released in response to the register file changing to the full status due to the write request being processed.

The writer may be stalled in response to the register file being in the full status.

The writer may be released in response to the register file changing to the empty status due to the read request being processed.

In another general aspect, there is provided a thread synchronization method including determining a status of a register file in response to receiving one data processing request from one thread, and stalling the one thread, according to the status of the register file, until another data processing request from another thread is processed.

The one data processing request may be a data read request, the other data processing request may be a data write request, and the data read request may be stalled in response to the status of the register file being empty.

The one data processing request may be a data write request, the other data processing request may be a data read request, and the data write request may be stalled in response to the status of the register file being full.

The method may further include releasing the one thread in response to the status of the register file changing due to the processing of the other data processing request from the other thread.

Other features and aspects may be apparent from the following detailed description, the drawings, and the claims.

### BRIEF DESCRIPTION OF THE DRAWINGS

FIG. 1 illustrates an example of a thread synchronization apparatus.

FIG. 2 is a flowchart illustrating an example of operation of a controller.

FIG. 3 illustrates an example of a register file.

FIG. 4 illustrates an example of a controller.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

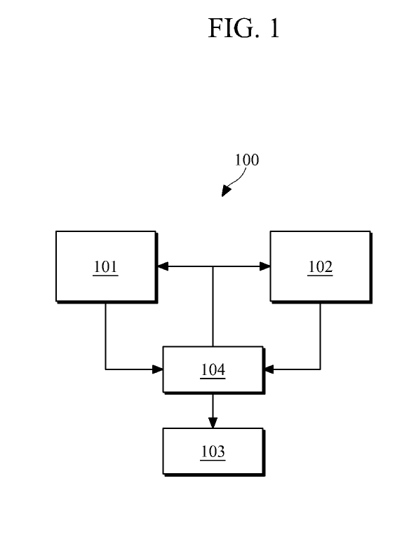

FIG. 1 illustrtaes an example of a thread synchronization apparatus 100.

Referring to FIG. 1, the thread synchronization apparatus 100 may be a part of a coarse-grained configurable array (CGRA) that simultaneously processes a plurality of threads. The example thread synchronization apparatus 100 includes a reader 101, a writer 102, a register file 103, and a controller 104.

The reader 101 generates a data read request to request the controller 104 to read data from the register file 103. For example, the reader 101 may be a processing unit of a CGRA or a read thread that is executed by a processing unit of a CGRA. Also, in the current example, a plurality of readers may be provided.

The writer 102 generates a data write request to request the controller 104 to write data in the register file 103. For example, the writer 102 may be a processing unit of a CGRA or a write thread that is executed by a processing unit of a CGRA. Also, in the current example, a plurality of writers may be provided.

The register file 103 stores data which may be written or read by the controller 104 according to requests by the reader 101 and writer 102, and maintains one of two statuses for synchronization of the reader 101 and writer 102. One of the two statuses of the register file 103 is a full status indicating that the register file 103 stores data, and the other of the two statuses of the register file 103 is an empty status indicating that the register file 103 stores no data. For example, the register file 103 may include several registers, and each register may have a first area for representing the full or empty status, and a second area for storing data that is requested be read by the reader 101 or written by the writer 102.

The controller 104 may receive a data read request from the reader 101 or a data write request from the writer 102, and may process the received data read request or data write request according to the status of the register file 103.

Also, the controller 104 may stall or release, if previously stalled, the reader 101 or writer 102 according to the status of the register file 103 and the status of the reader 101 or writer 102. For example, in a case in which the controller 104 receives a data read request from the reader 101 or a data write request from the writer 102, the controller 104 determines whether the register file 103 is in the full status or in the empty status, and stalls the reader 101 or writer 102 or releases the stalled reader 101 or writer 102 according to the result of the determination.

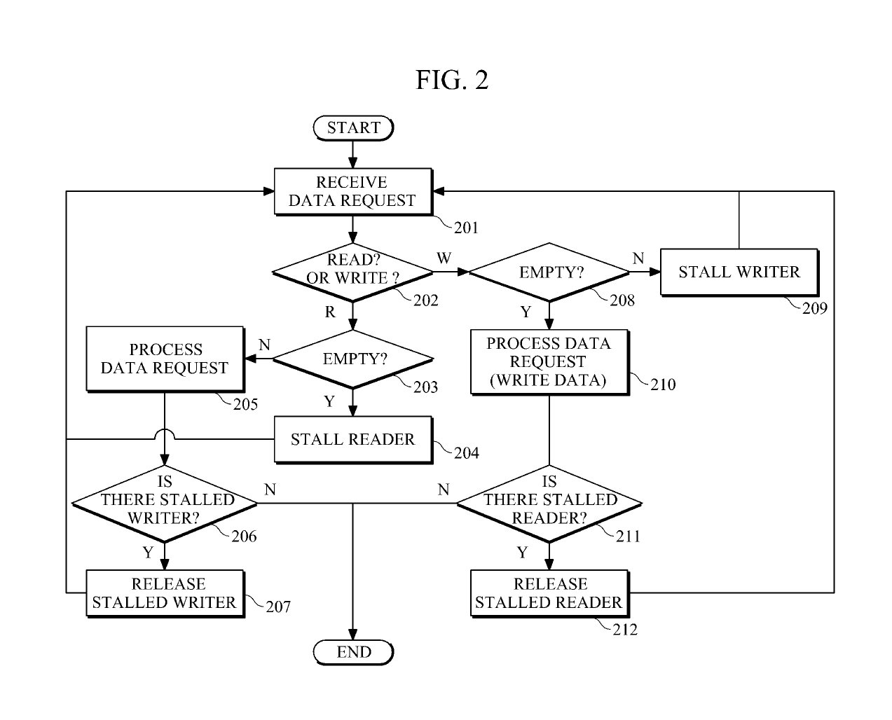

FIG. 2 is a flowchart illustrating an example of operation of the controller 104.

Referring to FIGS. 1 and 2, the controller 104 receives a data request from the reader 101 or writer 102 (201), and determines whether the received data request is a data read request or a data write request (202).

If the controller 104 determines that the received data request is a data read request, the controller 104 determines whether the register file 103 is in the full status or in the empty status (203). To perform the determination, the controller 104 may, for example, check a bit value of a 1-bit area representing whether the register file 103 is in the full status or in the empty status, thereby determining whether the register file 103 is in the full status or in the empty status. However, the procedure for determining the status of the register file 103 is not limited to this example.

If the register file 103 is in the empty status, the controller 104 stalls the reader 101 that has generated the data read request (204).

Conversely, if the register file 103 is in the full status, the controller 104 processes the received data read request (205). For example, the controller 104 may provide data stored in the register file 103 to the reader 101.

In response to processing the received data read request, the controller 104 determines whether there is a writer 102 that was previously stalled (206). The determination of whether there is a previously stalled writer 102 may be made by referring to a list of stalled threads. For example, in response to the controller 104 stalling a certain reader 101 as in operation 204, the controller 104 may write an identifier of the stalled reader 101 and a number of the corresponding register in a table. However, this is only an example of how such a list or table may be maintained, and the determination of whether there is a previously stalled writer 102 is not limited to such a process. As another example, the controller 104 may monitor the reader 101 or the writer 102 to determine whether the operating status of the reader 101 or writer 102 is in a normal status or in a stalled status. In the description of this example, the normal status refers to a released status.

If the controller 104 determines that there is a previously stalled writer 102 after processing the received data read request, the controller 104 releases the stalled writer 102 (207).

Meanwhile, if the controller 104 determines that the received data request is a data write request in operation 202, the controller 104 determines whether the register file 103 is in the full status or in the empty status (208). As described above, the controller 104 may check a bit value of a 1-bit area representing whether the register file 103 is in the full status or in the empty status, thereby determining whether the register file 103 is in the full status or in the empty status. As also previously stated, the determination of the status of the register file 103 is not limited to such a process.

If the register file 103 is in the full status, the controller 104 stalls the writer 102 that has generated the data write request (209).

Conversely, if the register file 103 is in the empty status, the controller 104 processes the received data write request (210). For example, the controller 104 may write data received from the writer 102 in the register file 103.

In response to processing the received data write request, the controller 104 determines whether there is a reader 101 that was previously stalled (211). As described above, the controller 104 may determine whether there is a previously stalled reader 101 based on a list of stalled threads, by monitoring the operating status of the reader 101 or writer 102, or other such process.

If the controller 104 determines that there is a previously stalled reader 101 stalled processing the received data write request, the controller 104 releases the stalled reader 101 (212).

Accordingly, thread synchronization is possible as described in the following examples, which are not limiting in any fashion to any of the methods, apparatuses, processes, and/or systems described herein.

For example, if the reader 101 generates a data read request and the register file 103 is in the empty status, the controller 104 may stall the reader 101 without processing the data read request, until the register file 103 is filled with data by the writer 102 (that is, until the register file 103 enters the full status). In other words, since the reader 101 fetches data from the register file 103 after the register file 103 is filled with data by the writer 102, thread synchronization can be performed.

Also, as another non-limiting example, if the writer 102 generates a data write request and the register file 103 is in the full status, the controller 104 may stall the writer 102 without processing the data write request, until the register file 103 is empty, such as after being read by the reader 101 (that is, until the register file 103 enters the empty status). In other words, since the writer 102 writes data in the register file 103 after the register file 103 is empty, such as, for example, after being read by the reader 101, thread synchronization can be performed.

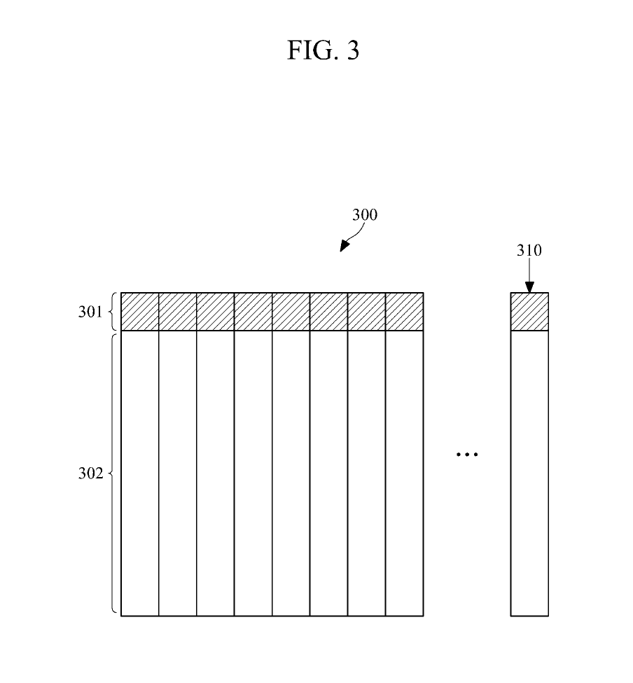

FIG. 3 illustrates an example of a register file 300.

Referring to FIG. 3, the register file 300 may include a plurality of registers 310. Each register 310 may have a first area 301 and a second area 302.

In one example, the first area 301 may include two bits. In such an example, one of the two bits may be an enable bit representing whether or not the corresponding register 310 is to be used as a register for synchronization, and the other one of the two bits may be a status bit representing whether the corresponding register 310 is in the full status or in the empty status. For example, if the status bit is 0, the full status may be indicated for the corresponding register 310, and if the status bit is 1, the empty status may be indicated for the corresponding register 310. In other examples, the values of the status bits may be reversed, or different methods of indicating the status of the register 310 may be used.

The second area 302 is an area for data corresponding to a data read request or a data write request. For example, in response to a data write request, data is written in the second area 302, and in response to a data read request, data is read from the second area 302.

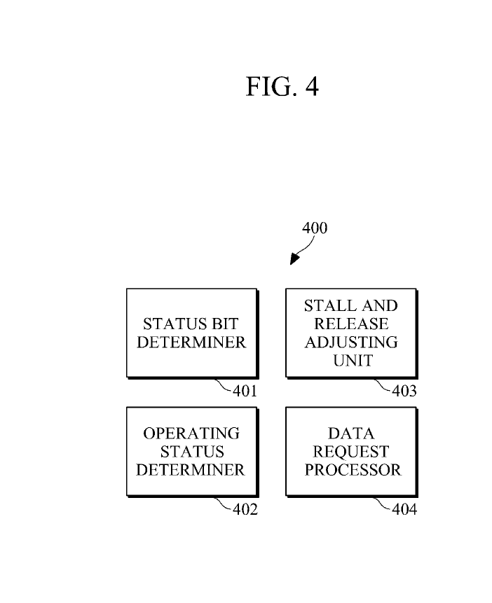

FIG. 4 illustrates an example of a controller 400.

Referring to the example illustrated in FIG. 4, the controller 400 includes a status bit determiner 401, an operating status determiner 402, a stall and release adjusting unit 403, and a data request processor 404. The following description will be given with reference to FIGS. 1 and 3.

The status bit determiner 401 checks a status bit of the first area 301 of a corresponding register 310 illustrated in FIG. 3, thus determining whether the corresponding register 310 is in the full status or in the empty status.

The operating status determiner 402 determines whether the reader 101 or writer 102 illustrated in FIG. 1 is in a normal status or in a stalled status. The determination of whether the reader 101 or writer 102 is in a normal status or in a stalled status may be done by various methods. For example, the controller 400 may determine whether a specific reader 101 or writer 102 is in a normal status or in a stalled status by writing an identifier of the reader 101 or writer 102 and a number of the corresponding register in response to the controller 400 stalling the reader 101 or writer 102, or by detecting a pin signal of a processing unit, or other such methods.

The stall and release adjusting unit 403 stalls a specific reader 101 or writer 102 or resumes a stalled reader 101 or writer 102. For example, the stall and release adjusting unit 403 may stall, if the register file 103 is empty and a first thread requests reading of data stored in the register file 103, the first thread until the register file 103 is filled with data by a second thread. Also, as another example, if the register file 103 is filled with data and a third thread requests data writing to the register file 103, the stall and release adjusting unit 403 may stall the third thread until the register file 103 is empty after a reading operation requested by a fourth thread.

The data request processor 404 processes a data request from the reader 101 or writer 102. For example, the data request processor 404 may provide data stored in the register file 103 in response to a data read request from the reader 101. Also, the data request processor 404 may write data in the register file 103 in response to a data write request from the writer 102.

The above-described examples may synchronize multiple threads without having to use a complicated configuration, since stalling and release of the threads are adjusted according to registers and status bits of registers. Accordingly, a first thread of reading data from a register file may be synchronized to a second thread of writing data in the register file, without utilizing a separate factor such as semaphore in terms of programming.

The processes, functions, methods, and/or software described herein may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A thread synchronization apparatus comprising:
a reader configured to generate a data read request;
a writer configured to generate a data write request;
a register file configured to have a full status indicating that the register file stores data and an empty status indicating that the register file stores no data; and
a controller configured to receive the data read request from the reader or the data write request from the writer, and to process the received data read request or the received data write request while stalling or releasing the reader or the writer according to whether the register file is in the full status or in the empty status and according to an operating status of the reader or the writer.

2. The thread synchronization apparatus of claim 1, wherein the controller stalls the reader in response to the register file being in the empty status and the data read request being received from the reader.

3. The thread synchronization apparatus of claim 2, wherein the controller stalls the reader until the register file enters the full status due to the data write request from the writer being processed.

4. The thread synchronization apparatus of claim 3, wherein the controller changes the register file to the full status in response to processing the data write request from the writer.

5. The thread synchronization apparatus of claim 1, wherein if the register file is in the full status and the data read request is received from the reader, the controller processes the received data read request, determines whether the writer is in a stalled status, and releases, in response to the writer being in the stalled status, the stalled status of the writer.

6. The thread synchronization apparatus of claim 1, wherein if the register file is in the full status and the data write request is received from the writer, the controller stalls the writer.

7. The thread synchronization apparatus of claim 6, wherein the controller stalls the writer until the register file enters the empty status due to the data read request from the reader being processed.

8. The thread synchronization apparatus of claim 7, wherein the controller changes the register file to the empty status in response to processing the data read request from the reader.

9. The thread synchronization apparatus of claim 1, wherein if the register file is in the empty status and the data write request is received from the writer, the controller processes the received data write request, determines whether the reader is in a stalled status, and releases, in response to the reader being in the stalled status, the stalled status of the reader.

10. The thread synchronization apparatus of claim 1, wherein the register file includes a first area for storing data indicating the full status or the empty status, and a second area for storing data corresponding to the data read request or the data write request.

11. A thread synchronization apparatus configured to stall a first thread until a register file is filled with data by a second thread, in response to the register file being empty and the first thread generating a data read request for reading data stored in the register file, and
to stall a third thread until the register file is empty due to processing a fourth thread, in response to the register file being filled with data and the third thread generating a data write request for writing data to the register file.

12. A thread synchronization method comprising:
receiving a data read request from a reader or a data write request from a writer;
determining whether a register file is in a full status or empty status, wherein the full status indicates that the register file stores data and the empty status indicates that the register file stores no data;
determining whether the reader or the writer is in a stalled status or in a released status; and
processing the received data read request or the received data write request while stalling or releasing the reader or the writer according to whether the register file is in the full status or in the empty status and according to an operating status of the reader or the writer.

13. The method of claim 12, wherein the reader is stalled in response to the register file being in the empty status.

14. The method of claim 12, wherein the reader is released in response to the register file changing to the full status due to the write request being processed.

15. The method of claim 12, wherein the writer is stalled in response to the register file being in the full status.

16. The method of claim 12, wherein the writer is released in response to the register file changing to the empty status due to the read request being processed.

17. A thread synchronization method comprising:
determining a status of a register file in response to receiving one data processing request from one thread; and
stalling the one thread, according to the status of the register file, until another data processing request from another thread is processed.

18. The method of claim 17, wherein the one data processing request is a data read request;
the other data processing request is a data write request; and
the data read request is stalled in response to the status of the register file being empty.

19. The method of claim 17, wherein the one data processing request is a data write request;
the other data processing request is a data read request; and
the data write request is stalled in response to the status of the register file being full.

20. The method of claim 17, further comprising releasing the one thread in response to the status of the register file changing due to the processing of the other data processing request from the other thread.
